(19) United States
(12) Patent Application Publication
(10) Pub. No.: US 2005/0220009 A1
(43) Pub. Date: Oct. 6, 2005

(54) Enhanced method and apparatus for managing a communication system

(76) Inventor: James B. Kargman, Chicago, IL (US)

Correspondence Address: GREENBERG TRAURIG, LLP, 77 WEST WACKER DRIVE, SUITE 2500, CHICAGO, IL, 60601-1732, US

(21) Appl. No.: 10/961,168

(22) Filed: Oct. 8, 2004

Related U.S. Application Data
(60) Provisional application No. 60/509,730, filed on Oct. 8, 2003.

(51) Int. Cl. H04J 3/14; H04J 1/16; H04L 1/00; G08C 15/00; H04L 12/26; H04L 12/56; H04L 12/28

(52) U.S. Cl. 370/225; 370/395.2

(57) ABSTRACT

A method and apparatus is provided which upon failure of a communication channel serves to redirect and/or reestablish communication via an alternative communication channel automatically in real time, without operator intervention where data is transmitted from a queue associated with one system or computer to a remote system or computer via one or more communication channels having one or more different types of formats. A communication server and a remote access service manager including a switchboard and a connector, serve to establish a communication channel to the remote system prescribed by the communication server, forward the message created by the communication server to the remote system and close the communication channel, wherein the switchboard tracks which connectors are available and in use and determines which connector to use, and wherein the connector makes a physical connection to the remote system.

### BACKGROUND OF THE INVENTION

1. Field of the Invention

The present invention relates to communication systems, and in particular, to a method and apparatus which upon failure of a communication channel serves to redirect and/or reestablish communication via an alternative communication channel automatically in real time, without operator intervention.

2. The Prior Art

It is common to have one or more computerized systems configured to transmit data to a secondary remotely located computer systems. The link between the two systems is commonly referred to as a communication channel. This communication channel can take many forms. In one primitive form, the communication channel may comprise a dial-up connection where a modem associated with the transmitting or originating system dials a telephone number associated with a modem associated with the receiving system towards establishing a communication over the public-switched telephone network. An alternative communication channel may comprise a “always on” communication link as might be established using the Internet and a DSL, cable modem or alternative communication link. Still further, more sophisticated communication channels may rely upon satellite technology and/or other closed direct connect communication channels.

Notwithstanding the highly developed state of communication technology, failures do occur whereby the ability to transmit data from one location to another is interrupted. It is typical practice to require human intervention to reestablish and/or reroute the data being transmitted by reestablishing communication via alternative communication channels. In some cases, human intervention is even required to detect a failure.

Accordingly it is an object of the present invention to provide a system that serves to reestablish a communication link using an alternative communication channel in real time so as to provide virtually uninterrupted transfer of data.

In many prior art situations, the interruption of a communication channel merely causes data to be warehoused or stored or buffered at the transmitting side towards a deferred transmission of data. However, many applications, require a much more reliable and uninterrupted communication channel without the necessity of installing, maintaining and paying for very sophisticated communication redundant high-cost always-on infrastructures.

In one application of the present invention, customers may provide orders for pizza by telephone or internet to a central location which, in turn, are routed to individual pizza restaurants which serve the geographic area within which the customer is located. These restaurants prepare the pizza and deliver the cooked product to the customer.

In the context of a pizza delivery system, orders which are received by phone, internet or other means into an order processing center must be transmitted to the appropriate pizza restaurant promptly in order that the customer's order for pizza is filled within a reasonable period of time, often 30 minutes which has become somewhat of an industry standard.

A further object of the present invention is to provide an enhanced “rollover” mechanism whereby the failure of a communication channel is detected and alternative communication links using alternative channels and/or even alternative communication types, are automatically established.

A still further object of the present invention is to provide for the ability to not only reestablish a communication link using an alterative communication channel of the same type as well as alterative communication channels of different types, but also the ability to automatically reconfigure/repackage or otherwise adjust the format of the overall data packet being transmitted towards adapting the data packet format to a new communication type on an automatic real-time basis without necessarily altering the contents of the data payload itself.

Another object of the present invention is to enable relatively low-cost, uninterrupted data communication from one point or system to another point or system, and in particular a communication system which is used to communicate requests to remote systems.

These and other desirable characteristics of the present invention will become apparent in view of the present specification and drawings.

### BRIEF DESCRIPTION OF THE DRAWINGS

FIG. 1 is a block diagram of the overall system specifically illustrating the communication server and remote access service managers (RASManager) according to a preferred embodiment of the invention;

FIG. 2 is a block diagram of the communication server according to the embodiment of FIG. 1;

FIG. 3 is a block diagram of the RASManager according to the embodiment of FIG. 1. specifically illustrating the switchboard and connector components according to a preferred embodiment of the invention;

FIG. 4 is a block diagram of the RASManager according to the embodiment of FIG. 1. specifically illustrating available connectors within the connector component of a preferred embodiment of the invention; and

FIG. 5 is a block diagram of the switchboard component of the RASManager according to a preferred embodiment of the invention.

### SUMMARY OF THE INVENTION

An apparatus is disclosed for directing communications in the event of the failure of a communication channel where data is transmitted from a queue associated with one system or computer to a remote system or computer via one or more communication channels having one or more different types of formats. The present the apparatus comprises a communication server and a remote access service manager.

A communication server functions to retrieve requests from a request queue, create messages containing data necessary for a remote system, determine the communication channel through which the message is to be exchanged, direct that a communication channel be established and messages be exchanged, process responses from the remote system and determines whether the communication channel should be closed.

The remote access service manager includes a switchboard and a connector, and functions to establish a communication channel to the remote system prescribed by the communication server, forward the message created by the communication server to the remote system, relay response messages from the remote system to the communication server and close the communication channel as directed by the communication server. The switchboard further tracks which connectors are available and which are in use and determines which connector to use triggering the connector to make a physical connection to the remote system.

### DETAILED DESCRIPTION OF THE DRAWINGS

While this invention is susceptible of embodiment in many different forms, there are shown in the drawings and will be described in detail, several specific embodiments, with the understanding that the present disclosure is to be considered as an exemplification of the principles of the invention and is not intended to limit the invention to the embodiments illustrated.

The present invention enables relatively low-cost, uninterrupted data communication from one point or system to another point or system, and in particular a communication system which is used to communicate requests to remote systems. While present disclosure is set forth in a context of communicating orders for goods and/or services from a order processing system to remotely located order fulfillment centers, and in particular, is disclosed in the context of the processing of orders from customers purchasing pizzas for delivery, the present invention is not limited thereto and accordingly has applicability to virtually any data communication system. Some examples of requests which need to be communicated in the context of processing of orders from customers purchasing pizzas are “place an order”, “give me your delivery time”, and “give me your hours of operation”. Some examples of remote systems are a store Point-Of-Sale System, a server that distributes requests to other systems, and a query server. Examples of responses include “order placed”, “hours of operation” and “customer address with that phone number”. Responses and requests are sometimes referred to herein as “messages”.

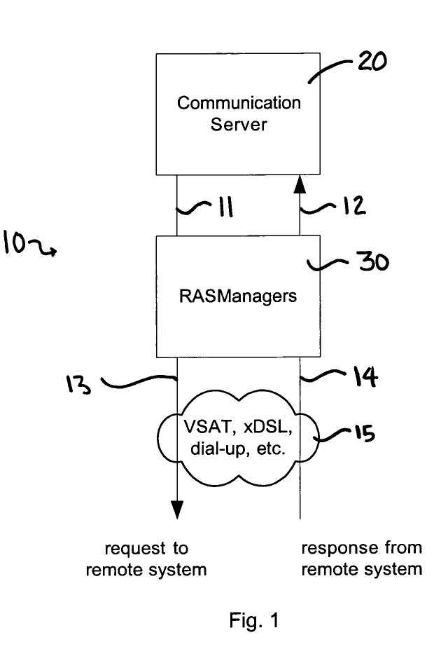

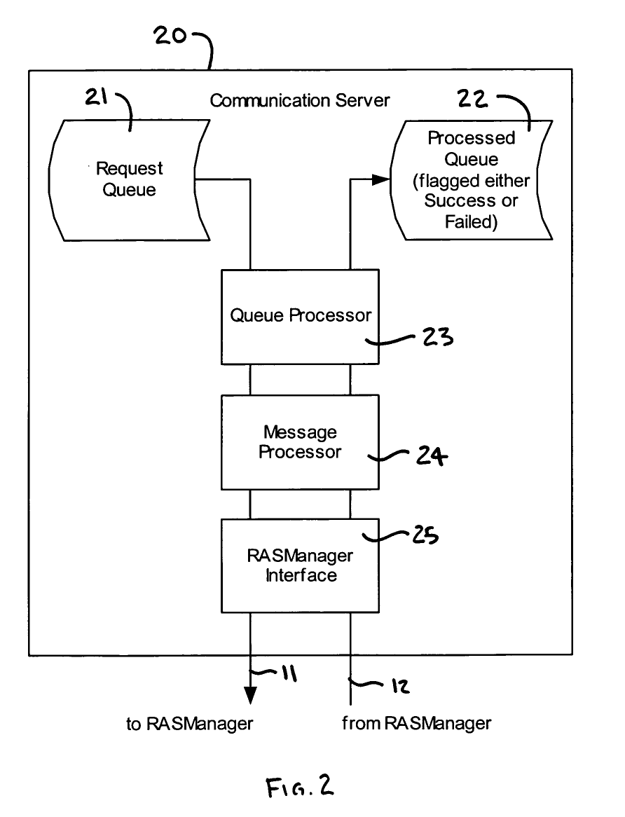

FIG. 1 of the drawings illustrates the overall communication system 10 and specifically the Communication Server 20 and one or more Remote Access service Managers (RASManager) 30. Communications between Communication Server 20 and RASManager 30 take place over input and output lines 11 and 12, respectively. Communications between the RASManager 30 and the remote system (not shown) take place via multiple alternative communication channels 15 over input and output lines 13 and 14, respectively. There are two types of hosts involved in communication subsystem disclosed which are referred to herein as the Communication Server 20 and the “RASManager” 30. The Communication Server 20 (FIG. 2) is responsible for: retrieving the next request(s) from a queue, determining the communication channel through which the messages will be exchanged, directing a RASManager 30 to establish the communication channel, creating messages containing the data necessary for the remote system to process the request, directing a RASManager 30 to send request messages, processing the response messages from the remote system relayed by the RASManager 30, determining if the RASManager 30 should immediately shut down the communication channel or leave it open, and making an entry in the processed queue.

Communication Server

The Communication Server 20 performs the highest-level activities in the communication system and serves, in part, to offload lower-level activities to the RASManager 30. As illustrated in FIG. 2, Communication Server 20 comprises a request queue 21, processed queue 22, queue processor 23, message processor 24 and a RASManager interface 25. Data output to RASManager takes place via line 11 and data input from RASManager takes place on line 12.

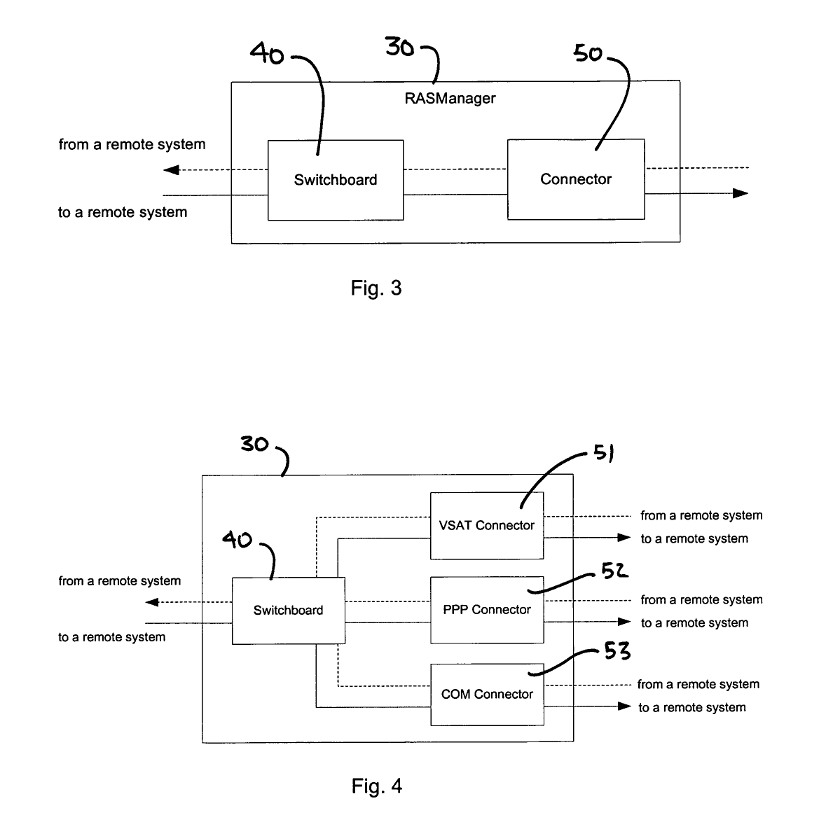

A RASManager 30 (FIG. 3) is responsible for: establishing the communication channel to the remote system prescribed by the Communication Server 20, forwarding the messages created by the Communication Server 20 to the remote system, relaying the response messages from the remote system back to the Communication Server 20, and closing the communication channel as directed by the Communication Server 20 or RASManager 30 inactivity timer.

Queue Processing

The Communication Server 20 processes queued requests on a first in-first out basis, (FIFO), using request queue 21 and queue processor 23. Each queue entry describes a type of operation to be performed by a remote host. For each queue entry, the Communication Server 20: determines the communication channel through which the messages will be exchanged, directs a RASManager 30 to establish the communication channel, creates messages containing the data necessary for the remote system to process the request, directs a RASManager 30 to send request messages, processes the response messages from the remote system relayed by the RASManager 30.

Requests either succeed or fail and are flagged as such in processed queue 22. The Communication Server 20 removes the queue entry after it determines whether the request was successful or not, and then places an entry in another queue managed by systems other than the communication system 10. At this point, the communication system 10 is finished with a request.

The Communication Server 20 allows each entry a certain (configurable) amount of time to be processed. If an entry is not processed in the allotted time, the Communication Server 20 considers the request to have failed regardless of where the “breakdown” occurs. The Communication Server 20 can process more than one request (queue entry) at a time, and more than one Communication Server 20 can process the request queue.

Determining a Communication Channel

The Communication Server 20 follows the communication channel rollover logic described below to determine which communication channel a RASManager 30 should try to establish with a remote system. After determining a communication channel, the Communication Server 20 then directs a RASManager 30 to establish a connection.

A remote host may have more than one communication channel. A primary communication channel is always defined and with one or more alternate communication channels optionally defined. For example: the primary communication channel may be DSL, with one or more alternate channels comprising dial-up modems.

The communication system 10 preferably tries the primary communication channel first. If the communication system 10 is unable to use the primary (for example, because it maybe down), the Communication Server 20 then executes the communication channel roll-over logic to determine which one to try next.

Directing a RASManager to Establish a Communication Channel

The Communication Server 20 does not itself establish the communication channel (a connection to a remote system), but rather, it directs a RASManager 30 to establish a connection and then uses the RASManager 30 as a proxy to exchange messages. This relieves the Communication Server 20 from the low-level details of establishing a connection—establishing a connection with remote systems over different systems.

The Communication Server 20 follows the RASManager 30 rollover logic to determine which RASManager 30 to use. The Communication Server 20 chooses a RASManager 30 to use, then directs that RASManager 30 to establish the channel.

If a RASManager 30 is unable to make a connection, it returns a failure response to the Communication Server 20. The Communication Server 20 then determines or selects a new communication channel. If a RASManager 30 is able to make a connection, it returns a success response back to the Communication Server 20. The Communication Server 20 then proceeds to create and exchange messages over the communication channel which as been established.

Creating Messages

The Communication Server 20 extracts information from the local database and formats it into one or more messages needed by the remote system to process a request using message processor 24. For example: a delivery time request may take only one message: “provide me with your delivery time” and a place order request may take one or more messages: “price this order”, “place this order”, and “provide me your delivery time”.

If the Communication Server 20 is unable to create a message (maybe a cross-reference is not defined), it considers the request to have failed.

After creating a message, the Communication Server 20 uses a RASManager 30 to exchange messages with a remote system via RASManager interface 25.

Exchanging Messages

It is through a RASManager 30 that the Communication Server 20 exchanges messages with the remote system. This relieves the Communication Server from the details of exchanging messages over different types of communication channels.

After a RASManager 30 makes a connection, the Communication Server 20 sends the messages to the RASManager 30 to be forwarded to the remote system, which, in turn, forwards them to the remote system. Messages for the remote system are placed inside of messages that give direction to the RASManager 30.

If the RASManager 30 is unable to send a message or obtain a response, it sends a failed reply back to the Communication Server 20. The Communication Server 20 directs the RASManager 30 to close the communication channel and determines a new communication channel and the RASManager 30 tries or fails the request. If the RASManager 30 is able to send the message and get back a response, it sends a success reply and the response message from the remote system back to the Communication Server 20. The Communication Server 20 then determines from the response message if the request was successful.

Processing a Response from the Remote System

The communication server inspects each response from the remote system relayed by the RASManager 30 using message processor 24. Even if a RASManager 30 successfully forwards a request to, and relays back a response from, the remote system, the remote system's response may indicate the remote system was unable to process the request (the store is closed, for example). Depending on the problem, the Communication Server may try to process the request again, or it may consider the request to have failed; the course of action it takes is configurable.

Determining if the RASManager Should Close the Connection

After processing a request, the Communication Server examines the queue to a depth (configurable) and determines if the RASManager 30 should immediately close the communication channel.

If another request is not found for the remote system, the Communication Server 20 directs the RASManager 30 to close the communication channel. If another request is found in the queue for the remote system, the Communication Server 20 does not tell the RASManager 30 to close the connection. The Communication Server 20 will use that RASManager 30 and communication channel for the next request in the queue going to that remote system. If a request has been processed and another request is going to be processed soon, it is more efficient to keep the communication channel up for the next request than to teardown and re-establish the communication channel, regardless of which communication channel was used.

RASManager Roll-Over Logic

The Communication Server 20 is configured with a list of RASManagers it can use. The next RASManager to use is determined using a round-robin schedule. The only exception is if the RASManager was not directed to close because another request was in the queue for the same remote system in which case, the RASManager with the established communication channel to the remote system will be used. If a RASManager 30 is unable to process a request because: all of its Connectors are in use, or the Communication Server 20 cannot establish a connection to it, the Communication Server 20 will use the next RASManager in the round-robin schedule to establish the same communication channel. The Communication Server 20 tries each RASManager a certain number of times (configurable) before it determines that no RASManager is available to process a request, then the Communication Server treats the request as failed.

Communication Channel Roll-Over Logic

A remote host may have more than one communication channel. A primary communication channel is always defined, with one or more alternate communication channels sometimes defined.

A remote host may have more than one communication channel. A primary communication channel is always defined, one or more alternate communication channels may also be defined. For example: the remote system may have a high-speed broadband connection that the communication system will always use as the primary connection; but if that medium is down, the remote system may also support one or more dial-up modem alternates that can be used by the communication system.

The communication system usually tries the primary communication channel first. The only exception is if a RASManager 30 was not directed to close after processing a previous request; in which case, it will continue to use the communication channel established by that RASManager (primary or alternate). If the primary communication channel cannot be used (maybe it is down) and there are one or more alternate communication channels, the Communication Server 20 directs the next RASManager in the RASManager schedule to try the next communication channel in the communication channel list. There is one exception: if the RASManager is unable to make a connection because it does not have a free connector that supports the prescribed communication channel, the Communication Server 20 will prescribe the same communication channel on a different RASManager.

If a communication channel to the remote system has not been made after trying the primary and all alternate communication channels, the Communication Server 20 starts re-using communication channel definitions, beginning at the top of the list. The Communication Server 20 will continue to cycle through this list until: the request is successful, a status that indicates the request cannot be processed is determined (store closed, for example), the number of configured attempts to establish a connection has been exceeded, or the allotted amount of time to process the request has expired. For the last three above situations, the Communication Server fails the request.

Scaling

If there is more than one entry in the queue, the Communication Server 20 can run multiple threads to process the queue—one thread for each queue entry (i.e., for each request). The number of queue entries a Communication Server 20 can process at the same time is configurable, so it can be tuned to the performance that the host can provide. For further scaling, multiple communication servers can process the same queue.

Communication servers 20 are configured with a list of RASManagers they can use and the connection types they provide. More than one Communication Server 20 can communicate with any RASManager, if configured to do so. These possibilities not only provide scalability and redundancy, but:

If a Communication Server fails, others process the queue using the same or different pool of RASManagers. If the current pool of Communication Servers is unable to support enough threads to process messages, another Communication Server can be added. If a RASManager fails, the pool of Communication Servers can use other RASManagers. If the current pool of RASManagers is unable to support enough threads to handle communications, another RASManager can be added.

RASManager

The RASManager 20: establishes the communication channel to the remote system prescribed by the Communication Server, forwards a message from the Communication Server to the remote system, relays the responses from the remote system back to the Communication Server, and closes the communication channel as directed by the Communication Server or inactivity timer.

The RASManager as illustrated in FIG. 3 has two components: Switchboard 40, and Connector 50. These perform lower-level activities for the Communication Server 20, giving the Communication Server 20 more time to perform the higher-level activities. More than one RASManager can be used by the Communication Servers to relay messages.

Switchboard

The Switchboard 40 determines which Connector 50 to use, as there is one type of Connector 50 for each type of communication channel as illustrated in FIG. 4. It also tracks which Connectors 50 are free and which are in use.

There is one type of Connector 50 for each type of communication channel and more than one instance of each Connector type running on the RASManager. In the embodiment of FIG. 4, VSAT Connector 51, PPP Connector 52 and COM Connector 53 are illustrated. The Switchboard 40 matches a connector with the communication channel prescribed by the Communication Server 20, and manages which Connectors are free and which are in-use.

The Switchboard 40 can use one or more of these Connectors 51-53 at the same time to handle multiple requests from Communication Servers 10. It uses Connectors 51-53 on a round-robin schedule.

If all Connectors 51-53 of the required type are in use, the Switchboard 40 signals the Communication Server 10 it has no free connectors of the required type. If a response comes back from a Connector 50 connected to a remote system for which a Communication Server 20 thread is no longer running, Switchboard 40 will ignore the response but not tell the Connector to close the communication channel.

It is important to note that the Switchboard 40 is a single executable and only one instance runs on a RASManager. This means the Communication Server needs only to communicate with, and direct, a single entity on the RASManager; it does not have to manage multiple entities (the Connectors).

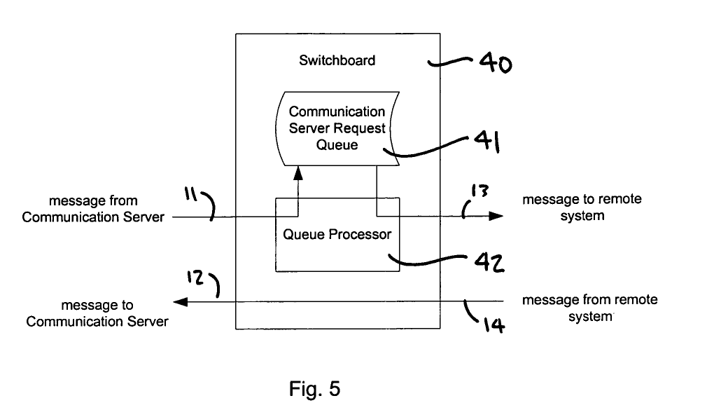

It is also important to note that the Switchboard 40, illustrated in FIG. 5, queues messages received from the Communication Server during a communication event, and then processes each queued message in a single uninterrupted thread. This prevents Communication Server communication events from interrupting, and subsequently compromising, RASManager message processing. As illustrated, Switchboard 40 comprises communication server request queue 41 and queue processor 42.

The Switchboard is not concerned with the details of the message or response, or the details of establishing an individual communication channel. The Connector and Communication Server 20 handle those details. The Switchboard's only concern is managing the type and number of communications channels.

Connector

The Connector is the lowest-level module of the communication system. It makes the physical connection to the remote system. Examples are: TCP over DSL, TCP over VSAT, dial-up, and PPP. The Connector is not concerned with the details of the message or response, or the status of any other communication channel but its own. The Switchboard 40 and Communication Server 20 handle those details. The Connector's only concern is the communication channel it brings up and tears down.

It is important to note that each Connector 50 is an instance of an executable, or thread. This allows a larger number of connections to be maintained on a single RASManager 30. Since each has its own thread: events fired by activity on a communication channel do not interrupt the activities of another communication channel, as they would if all communication channels were handled by the same thread, and the overhead of communicating with multiple Communication Servers (as Switchboard 40 does) does not compromise the integrity of the connection to the remote system.

The overhead for managing the queue of communications by Switchboard does not interfere with Switchboard 40 maintaining communications to a Communication Server 20 or Connector because the communication environment is closely controlled, unlike communications between a Connector 50 and remote system, which may be occurring over POTS or the Internet.

Establishing a Communication Channel

The RASManager 30 establishes a communication channel prescribed by the Communication Server 20. The RASManager Switchboard 40 receives the request, determines which Connector 50 to use, then forwards the request to the Connector 50. If the Connector 50 makes a connection, it relays a success reply back to the Switchboard 40. If the Connector cannot make a connection, it relays a failure reply back to the Switchboard 40. The Switchboard 40 relays the status back to the Communication Server 20.

Exchanging Messages

The RASManager 30 forwards messages from the Communication Server 20 to the remote system and relays responses from the remote system back to the Communication Server 20. The Switchboard 40 receives the message and passes it to the Connector 50 that established the communication channel to the remote system. If the Connector 50 sends a message and receives a response and receives a response, it sends a success reply and the response back to the Switchboard. If the Connector 50 is unable to send the message to the remote system, or it sends the message and does not receive a response, it sends a failure reply back to the Switchboard 40. The Switchboard 40 relays the status and response (if there is one) back to the Communication Server 20.

Closing the Communication Channel

A RASManager 30 closes the communication channel if: the Communication Server 20 directs it to do so or there has not been any activity over the communication channel for a period of time (inactivity timer, configurable). The Switchboard 40 controls the inactivity timer.

The foregoing description and drawings merely explain and illustrate the invention and the invention is not limited thereto, as those skilled in the art who have the disclosure before them will be able to make modifications and variations therein without departing from the scope of the invention.

1. An apparatus for directing communications in the event of the failure of a communication channel where data is transmitted from a queue associated with one system or computer to a remote system or computer via one or more communication channels having one or more different types of formats, the apparatus comprising:
a communication server which serves to retrieve requests from the queue, create messages containing data necessary for a remote system, determine the communication channel through which the message is to be exchanged, direct that a communication channel be established and messages be exchanged, process responses from the remote system and determine whether the communication channel should be closed;
remote access service manager, including a switchboard and a connector, which serves to establish a communication channel to the remote system prescribed by the communication server, forward the message created by the communication server to the remote system, relay response messages from the remote system to the communication server and close the communication channel as directed by the communication server, and in particular,
wherein the switchboard tracks which connectors are available and which are in use and determines which connector to use, and
wherein the connector makes a physical connection to the remote system.
